(19) United States
(12) Patent Application Publication
(10) Pub. No.: US 2005/0099976 A1
(43) Pub. Date: May 12, 2005

(54) Enabling mobile IPv6 communication over a network containing IPv4 components using a tunnel broker model

(76) Inventors: Shu Yamamoto, Cupertino, CA (US); Carl Williams, Palo Alto, CA (US); Hidetoshi Yokota, Saitama-Shi (JP); Kazuo Hashimoto, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/947,880

(22) Filed: Sep. 22, 2004

Related U.S. Application Data
(60) Provisional application No. 60/505,581, filed on Sep. 23, 2003.

(51) Int. Cl. H04J 3/24

(52) U.S. Cl. 370/331; 370/352; 370/401; 370/466; 370/395.54

(57) ABSTRACT

A mobile dual-stack node engages in IPv6 communication while roaming within an IPv4-only network. The node determines that it has moved and obtains a new IPv4 address. After determining that the visited network contains no IPv6-enabled components, the node communicates with a tunnel broker to obtain a care-of address and a tunnel to an IPv6 connect agent (e.g., a tunnel server). If the obtained care-of address differs from the care-of address that the node had been using prior to the move, the node sends MIPv6 binding updates to its home agent and corresponding peers. The node can optimize the handoff when it has obtained a different care-of address by sending a binding update to the connect agent comprising the previous care-of address and the current care-of address. When the connect agent receives a packet destined for the previous care-of address, it forwards the packet to the current care-of address.

### CROSS-REFERENCE TO RELATED APPLICATIONS

This application claims priority from the following U.S. provisional patent application, which is hereby incorporated by reference: Ser. No. 60/505,581, filed on Sep. 23, 2003, entitled “Using Mobile IPv6 Extensions in a Tunnel Broker Model (tunnel broker-MIPv6 service architecture).” This application is related to the following U.S. utility patent applications, which are hereby incorporated by reference: Ser. No. 10/436,679, filed on May 12, 2003, entitled “Internet Service Provider Facilitating IPv6 Connectivity Across a Customer's Network Containing IPv4 Components”; Ser. No. 10/729,257, filed on Dec. 4, 2003, entitled “Automatic IPv6 Connect Agent Discovery Using DNS”; and Ser. No. 10/818,662, filed on Apr. 5, 2004, entitled “Enabling Mobile IPv6 Communication Over a Network Containing IPv4 Components Using ISATAP.”

### FIELD OF INVENTION

The present invention relates generally to Internet Protocol communication, and specifically to enabling Mobile Internet Protocol Version 6 (MIPv6) communication over a network containing Internet Protocol Version 4 (IPv4) components using a tunnel broker model and MIPv6 handover optimizations.

### BACKGROUND OF INVENTION

Internet Protocol Version 6 (IPv6) is a new version of the Internet Protocol, designed as the successor to Internet Protocol version 4 (IPv4). Since IPv6 does not support mobility, packets addressed to a mobile IPv6 node (a node that dynamically changes its access point to the Internet) cannot reach the node when it is away from its home link. In order to support mobile IPv6 nodes, Mobile IPv6 (MIPv6) was created. MIPv6 enables mobile IPv6 nodes to remain reachable while they move around in IPv6 networks.

However, there are currently two versions of Internet Protocol in use: the widely used but older Internet Protocol Version 4 (IPv4) and the less used but newer Internet Protocol Version 6 (IPv6). If a mobile IPv6 node moves to an IPv4-only network, the mobile IPv6 node will be unable to continue IPv6 communication with its corresponding IPv6 peers. This is because the originating mobile IPv6 node would first have to communicate with an IPv4-only node, which then would have to communicate with the terminating IPv6 node. This is not supported by either IPv6 or MIPv6. While IPv6 is expected to gradually replace IPv4, the two versions will coexist for a number of years during the transition period. Thus, enabling a mobile IPv6 node to engage in IPv6 communication with other IPv6 nodes, even when the mobile IPv6 node is in an IPv4-only network, is an important concern among users of the Internet.

What is needed are methods and systems for a mobile IPv6 node in an IPv4-only network to engage in IPv6 communication across the IPv4-only network. The methods and systems should not require an upgrade of the IPv4-only network.

### SUMMARY OF INVENTION

In order to engage in IPv6 communication over a network containing no IPv6-enabled components, a mobile IPv6 dual-stack node uses a tunnel broker to obtain a Mobile IPv6 care-of address and a tunnel to an IPv6 connect agent.

The mobile IPv6 dual-stack node determines that it has moved. The node then obtains a new IPv4 address. The node determines that the visited network contains no IPv6-enabled components. The node finds a tunnel broker and uses the tunnel broker to obtain a Mobile IPv6 care-of address and a tunnel to an IPv6 connect agent, for example a tunnel server, which enables the node to engage in IPv6 communication over the IPv4-only network. If the tunnel broker is the same tunnel broker that the node had been using prior to the move, the node continues to use the same care-of address. If the tunnel broker is different, the node uses a new care-of address. In one embodiment, the tunnel broker provides the new care-of address. MIPv6 binding updates are then sent to the node's home agent and corresponding peers.

In one embodiment, the node and the connect agent (e.g., tunnel server) optimize the handoff. The node detects that it has moved and is using a different tunnel broker. The node then sends a binding update to the previous connect agent comprising the node's previous and current care-of addresses. The previous connect agent receives the binding update and, in one embodiment, stores the binding update in a binding cache that maps the previous care-of address to the current care-of address. Later, when the connect agent receives a packet destined for the node's previous care-of address, the connect agent forwards the packet to the node's current care-of address, thereby reducing packet loss.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1A is a block diagram illustrating a high level overview of a mobile dual-stack node in an IPv6 section of an IPv4 and IPv6 mixed network engaging in IPv6 communication over the mixed network, according to one embodiment of the present invention.

FIG. 1B is a block diagram illustrating a high level overview of a mobile dual-stack node in an IPv4 section of an IPv4 and IPv6 mixed network engaging in IPv6 communication over the mixed network, according to one embodiment of the present invention.

FIG. 2 is a block diagram of an enhanced protocol stack of a mobile dual-stack node, according to one embodiment of the invention.

FIG. 3 is a flowchart illustrating steps for a mobile dual-stack node to engage in IPv6 communication after it has moved to an IPv4-only network, according to one embodiment of the invention.

FIG. 4 is a flowchart illustrating steps for a mobile dual-stack node and an IPv6 connect agent to optimize handoffs when the node has moved within an IPv4-only network, according to one embodiment of the present invention.

The figures depict embodiments of the present invention for purposes of illustration only. One skilled in the art will readily recognize from the following discussion that alternative embodiments of the structures and methods illustrated herein can be employed without departing from the principles of the invention described herein.

### DETAILED DESCRIPTION OF PREFERRED EMBODIMENTS

The following description concerns methods and systems that enable a mobile IPv6 node located in a non-IPv6 enabled network to engage in IPv6 communication across the non-IPv6 enabled network. However, the present invention also applies to methods and systems that enable a node that can use a particular communication protocol to engage in communications using that protocol, even across a network that does not support that protocol.

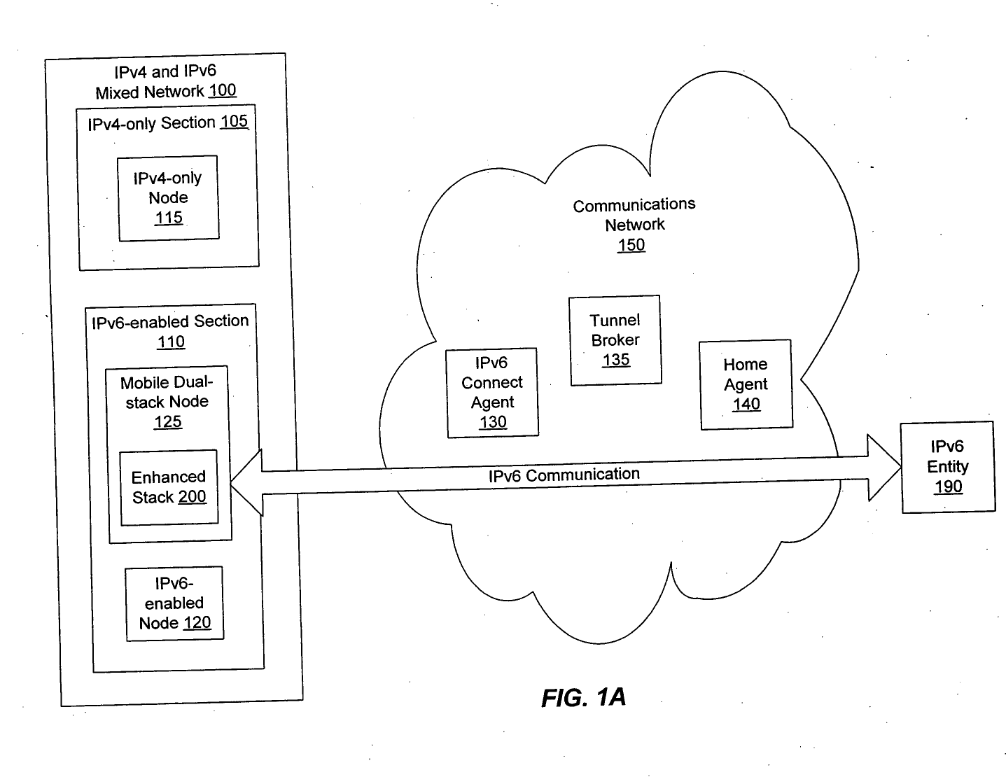

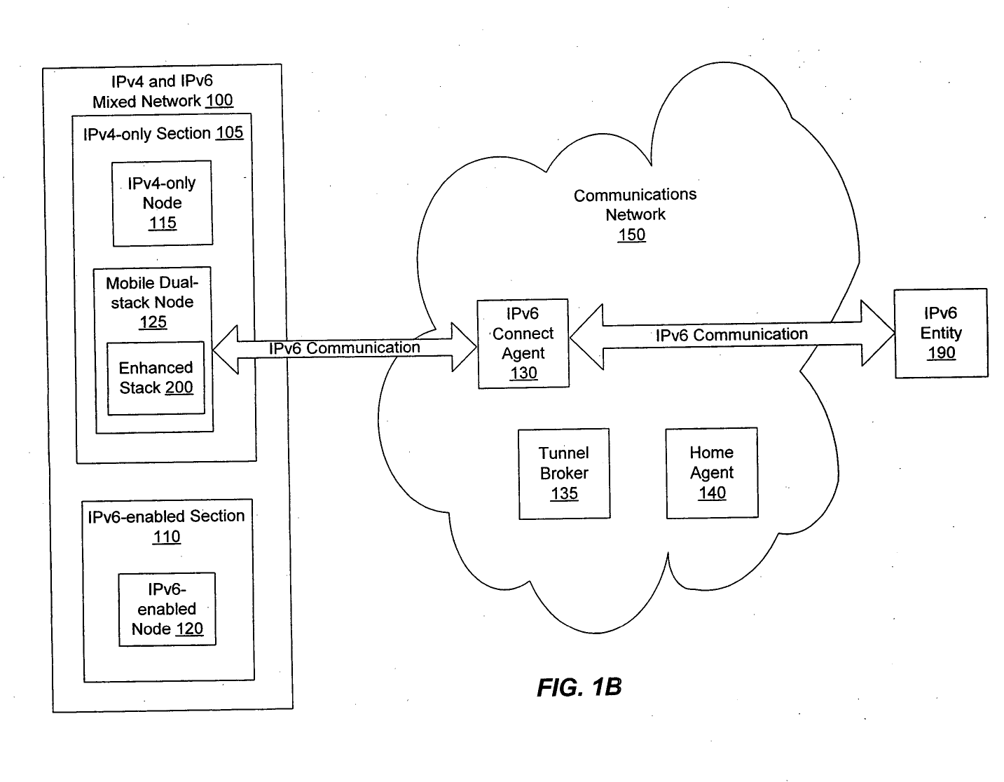

FIG. 1A is a block diagram illustrating a high level overview of a mobile dual-stack node 125 in an IPv6 section 110 of an IPv4 and IPv6 mixed network 100 engaging in IPv6 communication over the mixed network 100, according to one embodiment of the present invention. The illustrated embodiment includes a mixed network 100, a communications network 150, and an IPv6 entity 190. In the illustrated embodiment, mixed network 100 and IPv6 entity 190 are coupled to communications network 150.

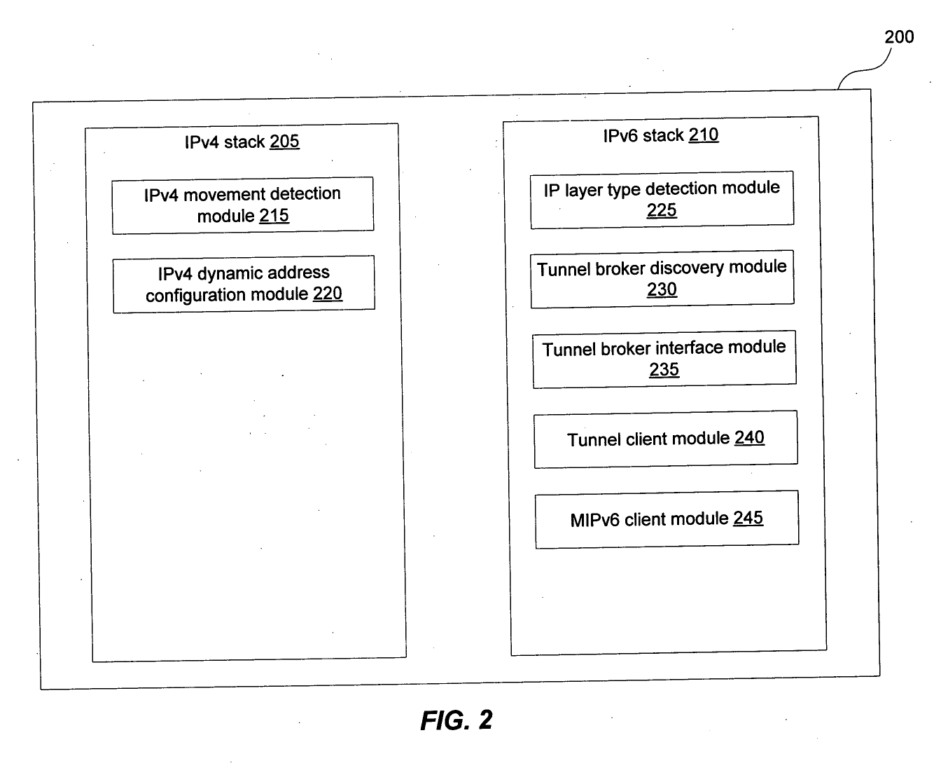

A mixed network 100 is a network that contains both IPv4-only components 105 and IPv6-enabled components 110. In the illustrated embodiment, mixed network 100 includes an IPv4-only section 105 and an IPv6-enabled section 110. IPv4-only section 105 includes one IPv4-only node 115, and IPv6-enabled section 110 includes one IPv6-enabled node 120 and one mobile dual-stack node 125. A dual-stack node 125 is a node that contains both an IPv4 stack and an IPv6 stack and thus can engage in both IPv4 and IPv6 communications. Dual-stack node 125 contains a memory module that stores machine-readable instructions for engaging in IPv4 and IPv6 communications. In one embodiment, these instructions include an enhanced protocol stack 200, which will be described below with reference to FIG. 2.

The illustrated architecture is used only by way of example. While FIG. 1A illustrates one IPv4-only node 115 in IPv4-only section 105, the present invention applies to any architecture containing one or more IPv4-only nodes 115 in IPv4-only section 105. In addition, while FIG. 1A illustrates one IPv6-enabled node 120 and one mobile dual-stack node 125 in IPv6-enabled section 110, the present invention applies to any architecture containing one or more IPv6-enabled nodes 120 and one or more mobile dual-stack nodes 125 in IPv6-enabled section 110.

Communications network 150 can include multiple processing systems (not shown) and comprises a local area network (LAN), a wide area network (WAN; e.g., the Internet), and/or any other interconnected data path across which multiple devices can communicate. In the illustrated embodiment, communications network 150 includes one IPv6 connect agent 130, one tunnel broker 135, and one home agent 140. This architecture is used only by way of example. While FIG. 1A illustrates one IPv6 connect agent 130, one tunnel broker 135, and one home agent 140, the present invention applies to any architecture containing zero or more IPv6 connect agents 130, zero or more tunnel brokers 135, and zero or more home agents 140. When more than one IPv6 connect agent 130 is available, a mobile dual-stack node 125 has a choice regarding which IPv6 connect agent 130 to use. Similarly, when more than one tunnel broker 135 is available, a mobile dual-stack node 125 has a choice regarding which tunnel broker 135 to use. In addition, while the illustrated embodiment shows the IPv6 connect agent 130, the tunnel broker 135, and the home agent 140 located externally to the network 100 containing the mobile dual-stack node 125, in another embodiment, the IPv6 connect agent 130, the tunnel broker 135, and/or the home agent 140 is/are located within the network 100 containing mobile dual-stack node 125.

An IPv6 connect agent 130 is a node that includes the functionality required to enable a mobile dual-stack node 125 residing in the IPv4-only section 105 of a mixed network 100 (or in an IPv4-only network) to engage in IPv6 communications across the network. IPv6 connect agent 130 will be further discussed below with respect to FIG. 1B.

A tunnel broker 135 is a node that includes the functionality required to setup an IPv6 tunnel between a mobile dual-stack node 125 residing in the IPv4-only section 105 of a mixed network 100 (or in an IPv4-only network) and an IPv6 connect agent 130. The tunnel enables the node 125 to engage in IPv6 communications across the IPv4-only section 105 of the mixed network 100 (or the IPv4-only network). Tunnel brokers 135 are known to those of ordinary skill in the relevant art and are further described in “IPv6 Tunnel Broker” (RFC 3053) by A. Durand, P. Fasano, I. Guardini, and D. Lento, January 2001. Tunnel broker 135 will be further discussed below with respect to FIG. 1B.

As shown in FIG. 1A, mobile dual-stack node 125 is located within the IPv6-enabled section 110 of mixed network 100. Since mobile dual-stack node 125 is located within the IPv6-enabled section 110, mobile dual-stack node 125 can use MIPv6 to send and receive packets while it is away from its home network (for example, using a home agent 140). In this embodiment, IPv6 connect agent 130 is not used.

FIG. 1B is a block diagram illustrating a high level overview of a mobile dual-stack node 125 in an IPv4 section 105 of an IPv4 and IPv6 mixed network 100 engaging in IPv6 communication over the mixed network 100, according to one embodiment of the present invention. FIG. 1B is similar to FIG. 1A except that the mobile dual-stack node 125 has moved within mixed network 100 from the IPv6-enabled section 110 to the IPv4-only section 105.

As discussed above, MIPv6 enables a mobile IPv6-enabled node to send and receive packets only while the mobile IPv6-enabled node 125 remains within an IPv6-enabled network (or within an IPv6-enabled section of a mixed network). MIPv6 does not enable communication when the mobile IPv6-enabled node 125 is located within an IPv4-only network (or within an IPv4-only section of a mixed network). Thus, IPv6 connect agent 130 is needed to enable IPv6 communication between mobile dual-stack node 125 and IPv6 entity 190 when mobile dual-stack node 125 is located in an IPv4-only network (or in the IPv4-only section 105 of a mixed network 100).

In one embodiment, IPv6 connect agent 130 is an IPv6 tunnel server. In this embodiment, IPv6 connect agent 130 implements an IPv6 tunneling protocol, such as, for example, IPv6-over-IPv4 or IPv6-over-UDP-IPv4. An IPv6 tunneling protocol enables a static dual-stack node residing in an IPv4-only network or in an IPv4-only section of a mixed network to engage in IPv6 communication over the IPv4-only or mixed network. Specifically, an IPv6 tunnel-enabled device, such as a router or server, enables an originating dual-stack node to tunnel packets to the IPv6 next-hop address through the IPv4-only network. In other words, the IPv4-only network is treated as a link layer for IPv6. IPv6 tunnels are known to those of ordinary skill in the relevant art and are further described in “Generic Packet Tunneling in IPv6 Specification” (RFC 2473) by A. Conta and S. Deering, December 1998.

As described above, tunnel broker 135 is a node that includes the functionality required to setup an IPv6 tunnel between a mobile dual-stack node 125 residing in the IPv4-only section 105 of a mixed network 100 (or in an IPv4-only network) and an IPv6 connect agent 130 (such as an IPv6 tunnel server). In one embodiment, tunnel broker 135 sets up a tunnel according to the Tunnel Setup Protocol. The Tunnel Setup Protocol (TSP) is known to those of ordinary skill in the relevant art and is further described in “IPv6 Tunnel Broker with the Tunnel Setup Protocol (TSP)” (Internet-Draft) by M. Blanchet, Feb. 9, 2004.

While an IPv6 tunnel enables IPv6 communication over an IPv4-only or mixed network, an IPv6 tunnel can be used with only static originating nodes, not mobile originating nodes. Mobile IPv6 does support the originating node moving and thereby changing its point of access to network 150. As discussed above, MIPv6 enables mobile IPv6-enabled nodes to remain reachable while they move around in IPv6-enabled networks. In MIPv6, each mobile node is always identified by its home address, regardless of its current point of attachment to the network. While situated away from its home, a mobile node is also associated with a care-of-address, which provides information about the mobile node's current location. IPv6 packets addressed to a mobile node's home address are transparently routed the node's care-of address. MIPv6 enables IPv6-enabled nodes to cache the binding of a mobile node's home address with its care-of address and to then send any packets destined for the mobile node directly to it at this care-of address. All IPv6-enabled nodes, whether mobile or stationary, can communicate with mobile nodes. MIPv6 is known to those of ordinary skill in the relevant art and is further described in “Mobility Support in IPv6” (Intemet-Draft) by D. Johnson, C. Perkins, and J. Arkko, June 2003.

In order to overcome the limitations of IPv6 tunnels and MIPv6, in one embodiment, the mobile dual-stack node 125 comprises inventive software components that enable the mobile dual-stack node 125 to move to an IPv4-only network and engage in IPv6 communication. The present invention is particularly advantageous because it does not require the IPv4-only elements 105 of the mixed network 100 or IPv4-only network to be upgraded to IPv6 to enable the mobile dual-stack node 125 to engage in IPv6 communication.

FIG. 2 is a block diagram of an enhanced protocol stack of a mobile dual-stack node, according to one embodiment of the invention. Enhanced stack 200 comprises an IPv4 stack 205 and an IPv6 stack 210. IPv4 stack 205 comprises IPv4 movement detection module 215 and IPv4 dynamic address configuration module 220. IPv6 stack 220 comprises IP layer type detection module 225, tunnel broker discovery module 230, tunnel broker interface module 235, tunnel client module 240, and MIPv6 client module 245.

In one embodiment, enhanced stack 200 further comprises a control module (not shown), which is communicatively coupled to IPv4 movement detection module 215, IPv4 dynamic address configuration module 220, IP layer type detection module 225, tunnel broker discovery module 230, tunnel broker interface module 235, tunnel client module 240, MIPv6 client module 245, and mixed network 100. The control module centrally controls the operation and process flow of a mobile dual-stack node 125, transmitting instructions and data to as well as receiving data from each module 215, 220, 225, 230, 235, 240, and 245.

IPv4 movement detection module 215 determines that an IPv4-enabled node has moved from one access point in a network to another access point. Specifically, IPv4 movement detection module 215 detects that the node has detached from one subnet or network and attached to a different subnet or network, thereby using a different router. If the node uses a wireline connection, the IPv4 movement detection module 215 detects that the node has physically detached itself from the network. If the node uses a wireless connection, the IPv4 movement detection module 215 detects that the node has stopped using a particular wireless access point. Methods of detecting network detachment and attachment are known to those of ordinary skill in the relevant art and are further described in “IP Mobility Support” (RFC 2002) by C. Perkins, October 1996.

IPv4 dynamic address configuration module 220 obtains an IPv4 address for an IPv4-enabled node. Methods of dynamically obtaining an IPv4 address, such as Dynamic Host Configuration Protocol (DHCP) or Point-to-Point Protocol (PPP), are known to those of ordinary skill in the art and are further described in “Dynamic Host Configuration Protocol” (RFC 2131) by R. Droms, March 1997 and “The Point-to-Point Protocol (PPP)” (RFC 1661) by W. Simpson (Ed.), July 1994.

IP layer type detection module 225 determines whether a node is in a network containing IPv6-enabled components. In one embodiment, a network contains IPv6-enabled components if a node in the network receives an IPv6 router advertisement. The node can wait to receive an IPv6 router advertisement or it can solicit one by sending an IPv6 router solicitation. IP layer type detection module 225 is coupled to mixed network 100.

Tunnel broker discovery module 230 determines the IPv4 address of a tunnel broker 135. In one embodiment, this is performed by sending an IPv4 anycast broadcast. In another embodiment, this is performed by contacting a Domain Name System (DNS) server, as explained in U.S. patent application Ser. No. 10/729,257 entitled “Automatic IPv6 Connect Agent Discovery using DNS” and filed on Dec. 4, 2003, which is hereby incorporated by reference in its entirety. Tunnel broker discovery module 230 is coupled to mixed network 100.

Tunnel broker interface module 235 communicates with a tunnel broker 135 in order to obtain an MIPv6 care-of address and an IPv6 tunnel to an IPv6 connect agent 130 (such as an IPv6 tunnel server).

Tunnel client module 240 implements a tunnel client so that a dual-stack node can use an IPv6 connect agent 130 (such as an IPv6 tunnel server) to send and receive IPv6 communications over an IPv4-only or mixed network.

MIPv6 client module 245 implements MIPv6, updating a node's care-of address by sending MIPv6 binding updates to the node's home agent 140 and corresponding peers.

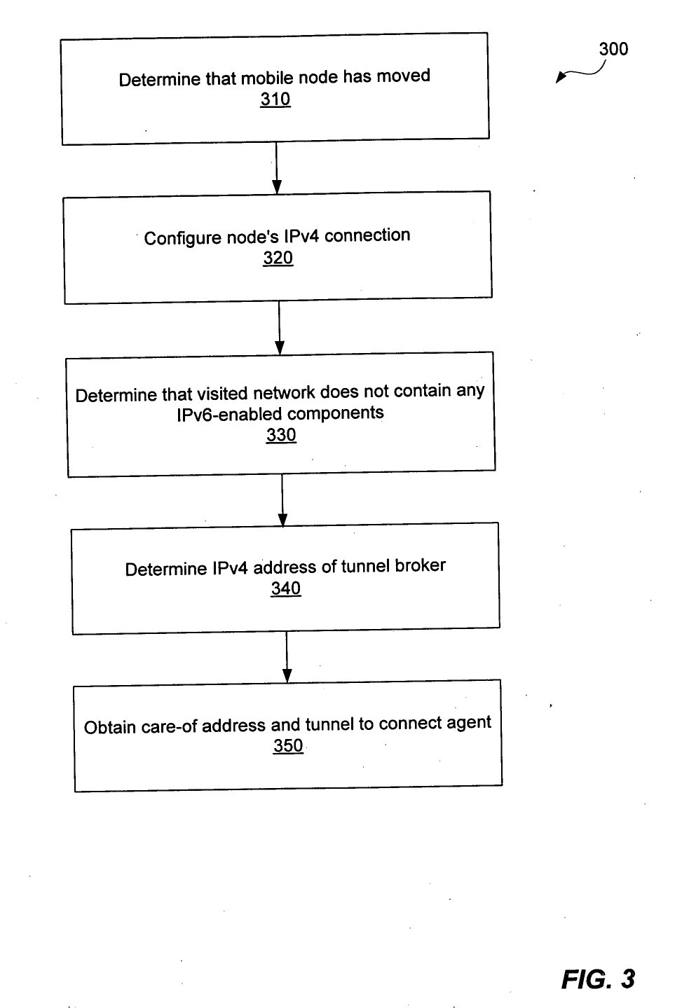

FIG. 3 is a flowchart illustrating steps for a mobile dual-stack node to engage in IPv6 communication after it has moved to an IPv4-only network, according to one embodiment of the invention. In the first step, the node 125 uses IPv4 movement detection module 215 to determine 310 that the node 125 has moved. For example, IPv4 movement detection module 215 sends a signal to the control module. Then, the node 125 uses IPv4 dynamic address configuration module 220 to configure 320 the node's IPv4 connection by dynamically obtaining a new IPv4 address.

The node 125 uses IP layer type detection module 225 to determine 330 whether the surrounding network contains any IPv6-enabled components. If the network contains one or more IPv6-enabled components, then the node 125 engages in IPv6 communication through the IPv6-enabled components (not shown). If the network contains no IPv6-enabled components, then the node 125 uses tunnel broker discovery module 230 to determine 340 the IPv4 address of a tunnel broker 135.

The node 125 uses tunnel broker interface module 235 to communicate with the discovered tunnel broker 135 in order to obtain 350 an MIPv6 care-of address and an IPv6 tunnel to an IPv6 connect agent 130 (such as an IPv6 tunnel server). If the discovered tunnel broker 135 is the same tunnel broker that the node had been using prior to the move, then the node continues to use the same care-of address.

If the tunnel broker 135 is different, the node uses a new care-of address. In one embodiment, the new tunnel broker 135 provides the new care-of address. The node 125 uses MIPv6 client module 245 to update the node's care-of address by sending MIPv6 binding updates to the node's home agent 140 and corresponding peers.

Once the tunnel has been established, the node 125 uses tunnel client module 240 to communicate with the IPv6 connect agent 130 (such as an IPv6 tunnel server), which enables the node 125 to send and receive IPv6 communications over an IPv4-only or mixed network, as shown in FIG. 1B.

Handover Optimization

In one embodiment, the handover that occurs when a mobile dual-stack node 125 moves within an IPv4-only network 105 is optimized. A mobile dual-stack node 125 in an IPv4-only network 105 uses an IPv6 connect agent 130 (such as an IPv6 tunnel server) to send and receive IPv6 communications. After the node 125 has moved within the IPv4-only network 105, it might use a different IPv6 tunnel server. If that is the case, in order to receive packets at its new location, the node 125 sends a binding update to its home agent 140 and corresponding nodes binding its previous care-of address to its current care-of address. Until the binding update has been received, packets that have already been sent to the node's previous care-of address can be lost.

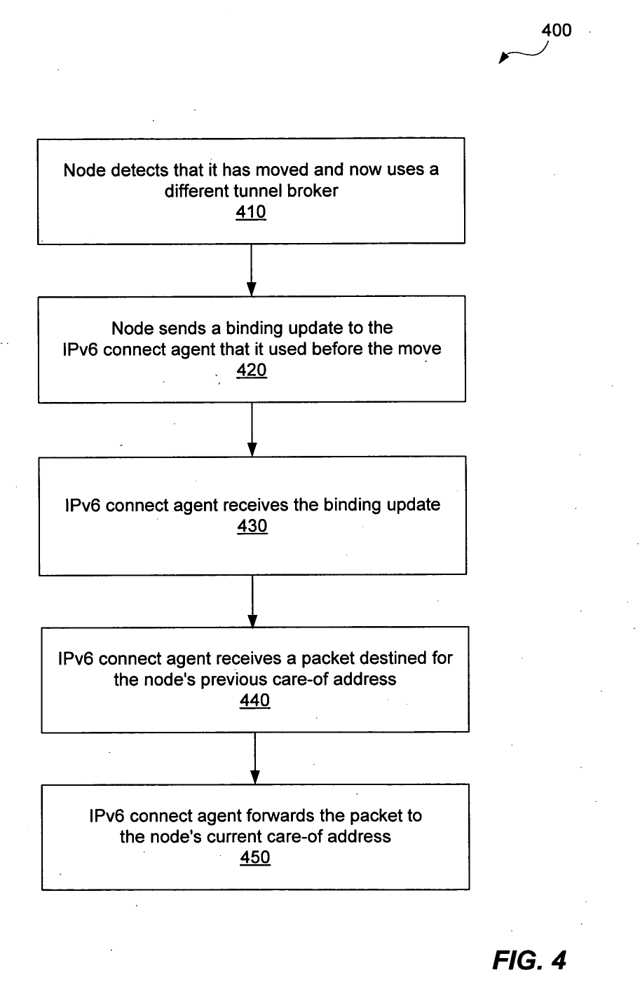

FIG. 4 is a flowchart illustrating steps for a mobile dual-stack node and an IPv6 connect agent to optimize handoffs when the node has moved within an IPv4-only network, according to one embodiment of the present invention. In this embodiment, packet loss is reduced by modifying an IPv6 connect agent 130 (such as an IPv6 tunnel server) so that it automatically forwards packets to a node's current care-of address. As described above, a mobile dual-stack node 125 in an IPv4-only network uses an IPv6 connect agent 130 to engage in IPv6 communication over the IPv4-only network. In the first step, mobile dual-stack node 125 detects 410 that it has moved within an IPv4-only network and now uses a different tunnel broker. Next, the node 125 sends 420 a binding update to the IPv6 connect agent 130 that it used before the move. This binding update binds the node's previous care-of address to the node's current care-of address. The IPv6 connect agent 130 then receives 430 the binding update. As a result, when the IPv6 connect agent 130 receives 440 a packet destined for the node's previous care-of address, the IPv6 connect agent 130 forwards 450 the packet to the node's current care-of address.

In one embodiment, this is achieved by adding a binding cache to the IPv6 connect agent 130 and by adding a modified binding update module to the mobile dual-stack node 125. In MIPv6, an entry in a binding cache maps a node's home address to its care-of address. In contrast, the present invention uses a binding cache entry that maps a node's previous care-of address to its current care-of address. This enables the IPv6 connect agent 130 to map packets that were sent to the mobile IPv6 dual-stack node's previous care-of address to the mobile IPv6 dual-stack node's current care-of address.

In one embodiment, the different nature of the binding update is noted by setting a flag in the message containing the binding update. In another embodiment, the binding update is of the same format as a standard MIPv6 binding update but, when sent to the IPv6 connect agent 130, comprises the node's previous care-of address rather than the node's home address.

The modified binding module detects when a node has moved within an IPv4 network and now uses a different tunnel broker. When this occurs, the modified binding module sends a binding update to the IPv6 connect agent 130 that it used before the move.

As will be understood by those familiar with the art, the invention can be embodied in other specific forms without departing from the spirit or essential characteristics thereof. Likewise, the particular naming and division of the modules, features, attributes, methodologies, nodes, servers, connect agents, and other aspects are not mandatory or significant, and the mechanisms that implement the invention or its features can have different names, divisions, and/or formats. Furthermore, as will be apparent to one of ordinary skill in the relevant art, the modules, features, attributes, methodologies, nodes, servers, connect agents, and other aspects of the invention can be implemented as software, hardware, firmware, or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific programming language or for any specific operating system or environment. Accordingly, the disclosure of the present invention is intended to be illustrative, but not limiting, of the scope of the invention.

1. A method for a node to engage in IPv6 communication across a network containing IPv4 components, the method comprising:
determining that the node has moved;
obtaining a new IPv4 address;
determining an IPv4 address of a tunnel broker;
obtaining a care-of address; and
obtaining a tunnel to an IPv6 connect agent.

2. The method of claim 1, wherein determining that the node has moved comprises:
detecting that the node has detached from one of a first network and a first subnetwork; and
detecting that the node has attached to one of a second network and a second subnetwork.

3. The method of claim 1, wherein obtaining the new IPv4 address comprises using one of Dynamic Host Configuration Protocol and Point-to-Point Protocol.

4. The method of claim 1, wherein determining that the visited network does not contain any IPv6-enabled components comprises not receiving, within a specified amount of time, an IPv6 router advertisement.

5. The method of claim 1, wherein determining the IPv4 address of a tunnel broker comprises one of sending an IPv4 anycast message and contacting a Domain Name System (DNS) server.

6. The method of claim 1, further comprising determining that a visited network does not contain any IPv6-enabled components.

7. The method of claim 1, further comprising sending, responsive to determining that the determined IPv4 address of the tunnel broker is identical to the IPv4 address of the tunnel broker that the node had previously used, a binding update to the IPv6 connect agent.

8. The method of claim 7, wherein sending the binding update to the IPv6 connect agent comprises sending a previous care-of address used by the node and the obtained care-of address.

9. A method for an IPv6 connect agent to optimize a handoff when a client node has moved within an IPv4-only network, the method comprising:
receiving a binding update, the binding update containing a first care-of address and a second care-of address; and
responsive to receiving a packet sent to the first care-of address, sending the packet to the second care-of address.

10. A system for a node to engage in IPv6 communication across a network containing IPv4 components, the system comprising:
a first module configured to determine that the node has moved;
a second module configured to obtain a new IPv4 address;
a third module configured to determine an IPv4 address of a tunnel broker;
a fourth module configured to obtain a care-of address;
a fifth module configured to obtain a tunnel to an IPv6 connect agent; and
a sixth module communicatively coupled to the first module, the second module, the third module, the fourth module, and the fifth module, and configured to send and receive signals.

11. The system of claim 10, further comprising a seventh module configured to determine that a visited network does not contain any IPv6-enabled components, wherein the sixth module is further communicatively coupled to the seventh module.

12. The system of claim 10, further comprising a seventh module configured to send, responsive to determining that the determined IPv4 address of the tunnel server is identical to the IPv4 address of the tunnel server that the node had previously used, a binding update to the IPv6 connect agent, wherein the sixth module is further communicatively coupled to the seventh module.

13. A system for an IPv6 connect agent to optimize a handoff when a client node has moved within an IPv4-only network, the system comprising:
a first module configured to receive a binding update, the binding update containing a first care-of address and a second care-of address;
a second module configured to send, responsive to receiving a packet sent to the first care-of address, the packet to the second care-of address; and
a third module communicatively coupled to the first module and the second module, and configured to send and receive signals.

14. A computer readable medium containing a computer program product for a node to engage in IPv6 communication across a network containing IPv4 components, the computer program product comprising:
program code for determining that the node has moved;
program code for obtaining a new IPv4 address;
program code for determining an IPv4 address of a tunnel broker;
program code for obtaining a care-of address; and
program code for obtaining a tunnel to an IPv6 connect agent.

15. The computer readable medium of claim 14, wherein determining that the node has moved comprises:
detecting that the node has detached from one of a first network and a first subnetwork; and
detecting that the node has attached to one of a second network and a second subnetwork.

16. The computer readable medium of claim 14, wherein obtaining a new IPv4 address comprises using one of Dynamic Host Configuration Protocol and Point-to-Point Protocol.

17. The computer readable medium of claim 14, wherein determining that a visited network does not contain any IPv6-enabled components comprises not receiving, within a specified amount of time, an IPv6 router advertisement.

18. The computer readable medium of claim 14, wherein determining an IPv4 address of a tunnel broker comprises one of sending an IPv4 anycast message and contacting a Domain Name System (DNS) server.

19. The computer readable medium of claim 14, the computer program product further comprising program code for determining that a visited network does not contain any IPv6-enabled components.

20. The computer readable medium of claim 14, the computer program product further comprising program code for sending, responsive to determining that the determined IPv4 address of the tunnel broker is identical to the IPv4 address of the tunnel broker that the node had previously used, a binding update to the IPv6 connect agent.

21. The computer readable medium of claim 20, wherein sending a binding update to the IPv6 connect agent comprises sending a previous care-of address used by the node and the obtained care-of address.

22. A computer readable medium containing a computer program product for an IPv6 connect agent to optimize a handoff when a client node has moved within an IPv4-only network, the computer program product comprising:
program code for receiving a binding update, the binding update containing a first care-of address and a second care-of address; and
program code for sending, responsive to receiving a packet sent to the first care-of address, the packet to the second care-of address.
